(19) United States
(12) Patent Application Publication
(10) Pub. No.: US 2024/0049112 A1
(43) Pub. Date: Feb. 8, 2024

(54) BASE STATION CONTROL APPARATUS, BASE STATION CONTROL METHOD, AND RECORDING MEDIUM RECORDING PROGRAM

(71) Applicant: NEC Corportion, Minato-ku, Tokyo (JP)

(72) Inventor: Kazuki Ogata, Tokyo (JP)

(73) Assignee: NEC Corporation, Minato-ku, Tokyo (JP)

(21) Appl. No.: 18/280,603

(22) PCT Filed: Mar. 8, 2021
(86) PCT No.: PCT/JP2021/008968

§ 371 Date: Sep. 6, 2023

(51) Int. Cl. H04W 48/06

(52) U.S. Cl. CPC H04W 48/06

(57) ABSTRACT

A control apparatus includes: a part for acquiring a number of moving bodies which travel between check points installed along a road; a part for selecting one or more sections of the road based on the number of moving bodies which travel between the check points; and a part for instructing the one or more base stations corresponding to the selected one or more sections of the road to execute one or more service restrictions at a predetermined timing.

### TECHNICAL FIELD

The present invention relates to a base station control apparatus, a base station control method, and a recording medium recording a program.

### BACKGROUND ART

In recent years, there are cases where communication failures occur due to natural disasters, such as typhoons, earthquakes or the like and it takes long time to recover the communication failure. One reason of the communication failures is depletion of power source for base stations. Each telecommunication carrier takes countermeasures, such as enforcement of backup power sources for the base stations, utilization of renewable energy, and so on.

Patent Literature (PTL) 1 discloses a backup power supply system which can extend a backup time length while reducing a cost to be expended for the backup power supply by appropriately controlling power consumption of a load (a base station) and an output of the backup power supply. Concretely, this backup power supply system acquires remaining battery capacity information of a storage battery and information regarding an operating status of the load when a main power supply is stopped. Then, the operation of the load is restricted according to the remaining battery capacity of the storage battery and the operating status of the load.

PTL 2 discloses a power demand control apparatus of a communication facility which can utilize a storage battery of the communication facility. The power demand control apparatus has a function to detect a certain communication base station whose traffic is less than or equal to a predetermined value among a plurality of the communication base stations and to make its storage battery be discharged to a transmission and distribution network side.

PTL 3 discloses a terminal apparatus which can determine presence or absence of congestion based on inter-vehicle communication. Concretely, the terminal apparatus receives vehicle data which includes at least information relating to a speed and a position of a vehicle from the other vehicle for inter-vehicle communication, combines the vehicle data with the data of the own vehicle to form a transmission frame and broadcasts the transmission frame. Then, when a travelling speed included in the vehicle data received form the other vehicle is less than or equal to a predetermined speed, the terminal apparatus determines that a road between two point-IDs included in the vehicle data is congested.

### CITATION LIST

### Patent Literature

PTL 1: Japanese Patent Kokai Publication No: 2015-70785
PTL 2: Japanese Patent Kokai Publication No: 2017-70159
PTL 3: WO2011/152022A1

### SUMMARY

### Technical Problem

The following analysis has been made by the present inventor. Base stations installed by each telecommunications carrier are utilized as an infrastructure to realize IoT (Internet of Things) and connected cars, and it is required for the base station to operate for a certain period of time after occurrence of a power outage due to occurrence of a natural disaster, such as a typhoon, an earthquake or the like. To deal with the requirement, each telecommunications carrier takes countermeasures, such as strengthening the backup power supply of the base station, utilization of renewable energy, and so on. However, usually, backup power supply is finite and operable time length is determined by its storage amount and consumption power of the base station.

Considering that these base stations are utilized for services for IoT or connected cars more and more in the future, a function to adapt a status and flexibly suppress consumption power while continuing to provide a service is required. Furthermore, it is assumed that even when there is not in a situation where the backup power supply is used, there is a need for providing a service while suppressing power consumption of base stations in response to a request from a system side.

In this respect, in a method of PTL 1, a frequency band with a low utilization rate is stopped based on a communication traffic of each frequency band of each base station. Because a determination is made for each base station, there is a possibility that a service provision area in a certain area may have a lot of zones in each of which a service is not provided.

It is an object of the present invention to provide a base station control apparatus, a base station control method, and a recording medium recording a program which can suppress power consumption in a way that is suitable for services for IoT or connected cars.

### Solution to Problem

According to a first aspect, there is provided a base station control apparatus, including: means for acquiring a number of moving bodies which travel between check points installed along a road; means for selecting one or more sections of the road based on the number of moving bodies which travel between the check points; and means for instructing the one or more base stations which form a service area of the selected one or more sections of the road to execute one or more service restrictions at a predetermined timing.

According to a second aspect, there is provided a base station control method, wherein a control apparatus of one or more base stations which form a service area corresponding to one or more sections of a road includes: acquiring a number of moving bodies which travel between check points installed along the road; selecting one or more sections of the road based on the number of moving bodies which travel between the check points; and instructing the one or more base stations which form a service area of the selected one or more sections of the road to execute one or more service restrictions at a predetermined timing. This method is associated with a certain machine, which is a control apparatus to instruct the one or more base stations to execute the service restrictions and so on.

According to a third aspect, there is provided a computer program (hereinafter, a “program”) for realizing the functions of the above control apparatus. This computer program is inputted to a computer apparatus via an input device or a communication interface from outside, is stored in a storage device, and drives a processor in accordance with predetermined steps or processing. In addition, this program can display, as needed, a processing result including an intermediate state per stage on a display device or can communicate with outside via the communication interface. As an example, the computer apparatus for this purpose typically includes a processor, a storage device, an input device, a communication interface, and as needed, a display device, which can be connected to each other via a bus. In addition, this program can be recorded in a computer-readable (non-transitory) storage medium. That is to say, the present invention can be realized by a computer program product.

### Advantageous Effects of Invention

According to the present invention, it is possible to suppress power consumption of the base station in a way that is suitable for services for IoT or connected cars.

### BRIEF DESCRIPTION OF DRAWINGS

FIG. 1 is a diagram illustrating a configuration according to an example embodiment of the present invention.

FIG. 2 is a diagram illustrating an operation according to the example embodiment of the present invention.

FIG. 3 is a diagram illustrating an operation according to the example embodiment of the present invention.

FIG. 4 is a diagram illustrating a further modified configuration according to the example embodiment of the present invention.

FIG. 5 is a diagram illustrating a system configuration according to a first example embodiment of the present invention.

FIG. 6 is a diagram illustrating an example of placements of one or more base stations which are control targets of a control apparatus according to the first example embodiment of the present invention.

FIG. 7 is a diagram illustrating an example of traffic flow information acquired by the control apparatus according to the first example embodiment of the present invention.

FIG. 8 is a diagram illustrating traffic flow information plotted between base stations, in FIG. 5.

FIG. 9 is a diagram illustrating an example of a basestation selection policy held by the control apparatus according to the first example embodiment of the present invention.

FIG. 10 is a sequence diagram illustrating an operation of the control apparatus according to the first example embodiment of the present invention.

FIG. 11 is a diagram illustrating an example of an operating state of the one or more base stations which received instructions from the control apparatus according to the first example embodiment of the present invention.

FIG. 12 is a diagram illustrating a system configuration according to a second example embodiment of the present invention.

FIG. 13 is a diagram illustrating an example of basestation information held by a control apparatus according to the second example embodiment of the present invention.

FIG. 14 is a diagram illustrating an example of a basestation selection policy held by the control apparatus according to the second example embodiment of the present invention.

FIG. 15 is a sequence diagram illustrating an operation of the control apparatus according to the second example embodiment of the present invention.

FIG. 16 is a diagram illustrating an example of one or more service restrictions instructed by the control apparatus according to the second example embodiment of the present invention.

FIG. 17 is a diagram illustrating the other example of one or more service restrictions instructed by the control apparatus according to the second example embodiment of the present invention.

FIG. 18 is a diagram illustrating a configuration of a computer which can function as a control apparatus of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and description of this outline is not intended to limit the present invention to any mode shown in the drawings or any limitation. An individual connection line between blocks in the drawings, etc., referred to in the following description includes both one-way and two-way directions. A one-way arrow schematically illustrates a principal signal (data) flow and does not exclude bidirectionality. In addition, although a port or an interface is present at an input/output connection point of an individual block in the relevant drawings, illustration of the port or the interface is omitted. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner.

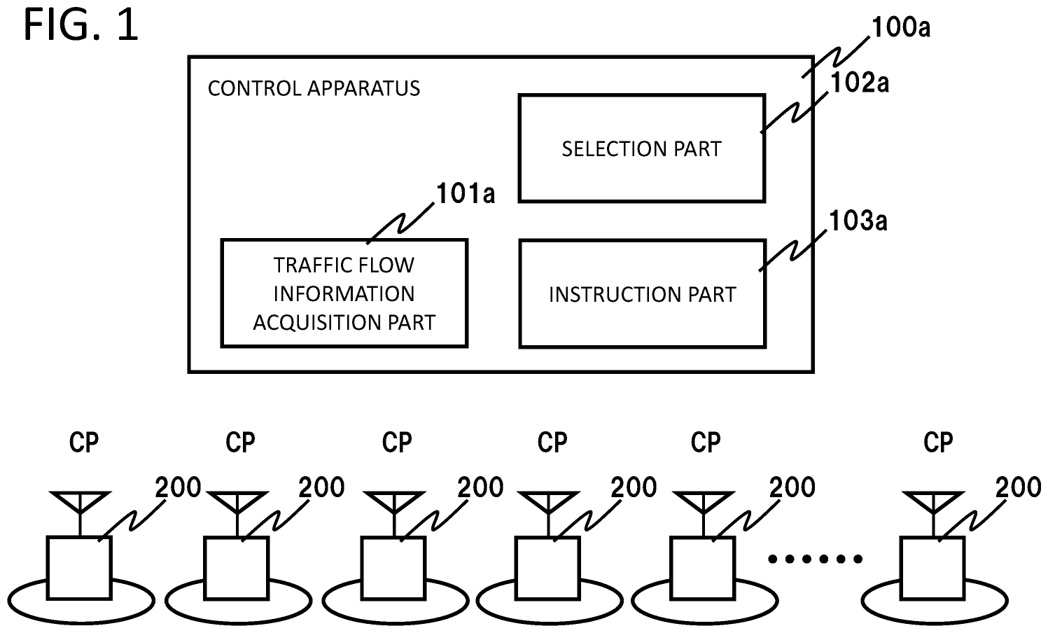

In an example embodiment, as illustrated in FIG. 1, the present invention can be realized by a control apparatus 100a which includes a traffic flow information acquisition part 101a, a selection part 102a, and an instruction part 103a.

The traffic flow information acquisition part 101a functions as means for acquiring the number of moving bodies which travel between check points (see CP shown in FIG. 1) installed along a road. Vehicles, pedestrians, IoT terminals, unmanned carriers, Unmanned Arial Vehicles, or robots are assumed as the moving bodies.

The selection part 102a functions as means for selecting one or more sections of the road based on the number of moving bodies which travel between the check points.

The instruction part 103a functions as means for instructing the one or more base stations 20 corresponding to the selected one or more sections of the road to execute one or more service restrictions at a predetermined timing.

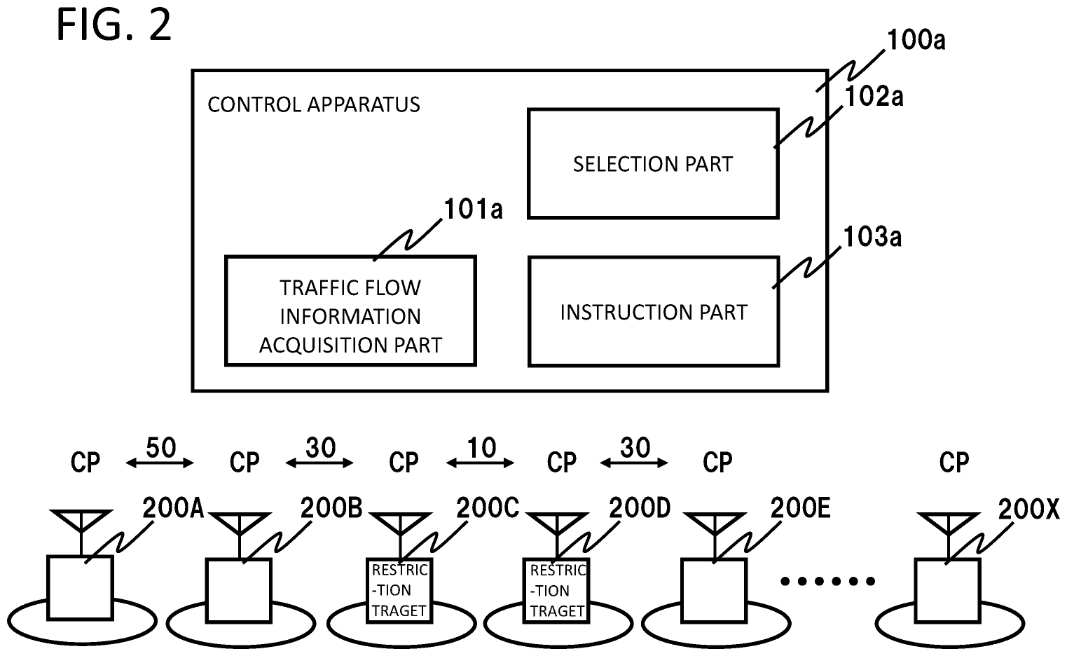

Next, an operation of the present example embodiment will be described in detail with reference to drawings. The traffic flow information acquisition part 101a acquires the number of moving bodies which travel between check points (hereinafter, also referred to “CP”) from a traffic control center or traffic flow sensors installed in along a road, although they are omitted. For example, as indicated by numerical values between CPs in FIG. 2, it is assumed that the number of moving bodies travelling between CPs are measured. Note, a unit of the numerical value may be the number of vehicles, the number of pedestrians, or an index value indicating an amount of a traffic flow which is calculated by applying a predetermined weighting to those numbers.

The selection part 102a selects one or more sections of a road based on the number of moving bodies which travel between the CPs. For example, the selection part 102a selects one or more sections of a road in which the number of moving bodies which travel between the CPs is less than a predetermined threshold value. For example, when the threshold value is 20 units, the selection part 102a selects a section of a road between a base station 200C and a base station 200D in which the number of moving bodies which travel between the CPs is less than 20 units. In addition, the selection of one or more sections can be performed by excluding one or more sections of a road in which the number of moving bodies which travel between the CPs is more than or equal to the predetermined threshold value.

The instruction part 103a instructs the base stations 200C and 200D corresponding to the selected section of the road to execute one or more service restrictions at a predetermined timing. For example, based on occurrence of a power outage or a power saving request from an electric power company, the instruction part 103a instructs the base stations 200C and 200D to execute one or more service restrictions. As the service restrictions, stopping of provision of various information from the one or more base stations 200, prohibition of a data upload via the one or more base stations 200, or the like can be exemplified as restriction. As described in PTL 1, the instruction part 103a may instruct to stop transmission of a radio wave for a particular frequency band.

As described above, the control apparatus 100a of the present example embodiment selects one or more sections of a road based on the number of moving bodies and so on which actually travel a road and instructs the one or more base stations corresponding to the one or more sections to execute one or more service restrictions. As a result, it becomes possible to suppress consumption power of one or more base stations for at least selected one or more sections of a road and to extend an operable period. In addition, for one or more sections of a road which are not selected as one or more sections in which one or more service restrictions are executed, it is possible to continue a service from one or more base stations. As a result, moving bodies such as vehicles, pedestrians or the like which travel the corresponding sections can receive provision of a conventional service.

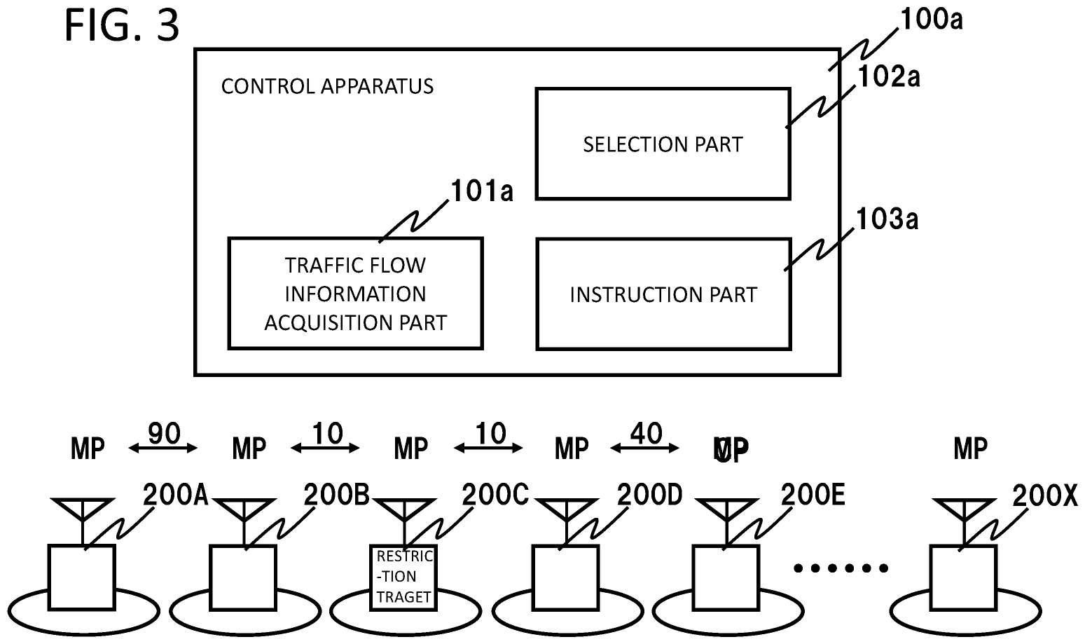

In addition, it is considered that there a lot of modes as selection methods of the above sections. In the example shown in FIG. 2, the control apparatus 100a selects a section of a road in which the number of moving bodies is less than a predetermined threshold value and selects base stations placed at the both end of the section of the road, but the selection method of the one or more base stations is not limited thereto. For example, as shown in FIG. 3, continuous sections for which the number of moving bodies is less than a predetermined threshold value are only selected and base stations in the continuous sections may be selected.

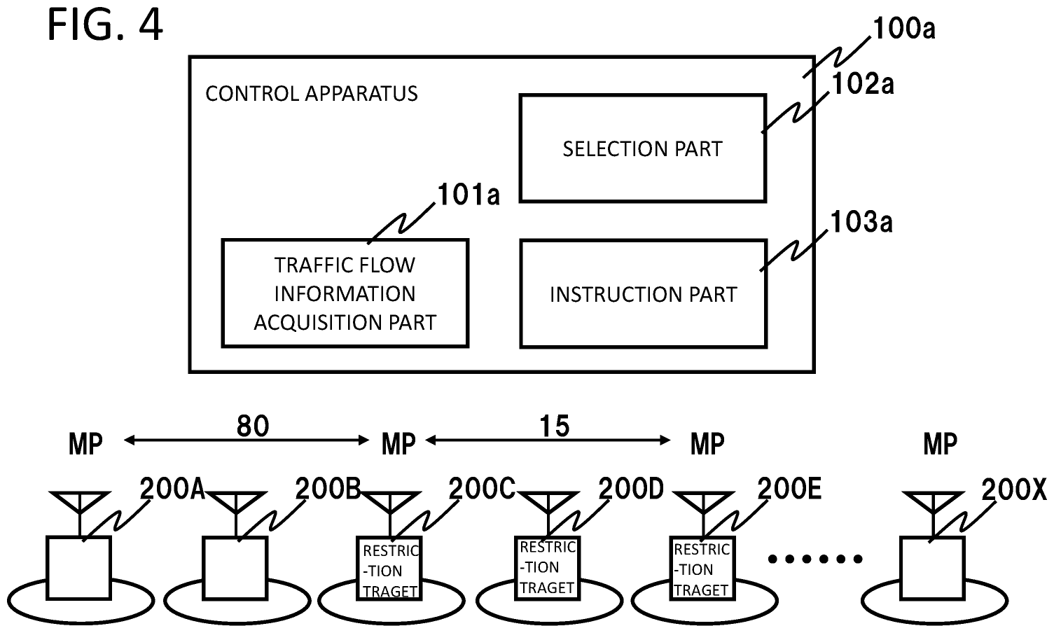

Furthermore, placement of base stations does necessarily coincide with placement of check points (CPs). For example, as shown in FIG. 4, when CPs are placed at a wider interval than the base stations, one or more sections of a road can be selected based on the CPs and the base stations corresponding to the one or more sections may be selected. For example, in the example as shown in FIG. 4, one or more sections of a road in which the number of moving bodies which travel between the CPs is less than 20 units are selected and the base stations 200C, 200D, and 200E corresponding to the one or more sections are selected. The selection of base stations according to one or more sections can be preferably utilized when there is a need to control base stations using existing traffic flow measurement sensors.

### First Example Embodiment

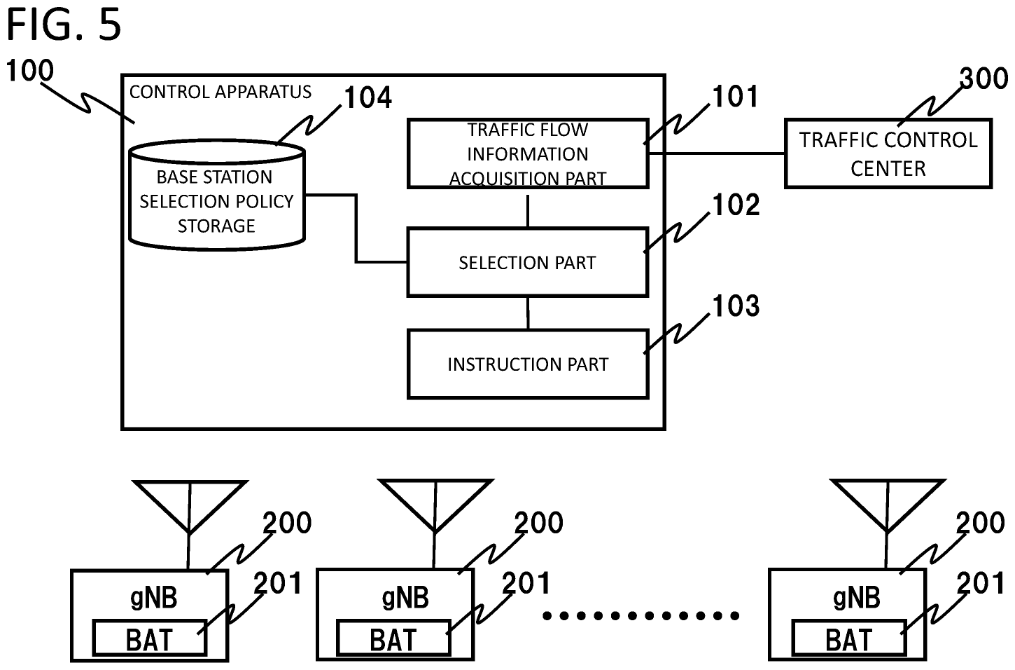

Next, a first example embodiment of the present invention will be described in detail with reference to drawings. FIG. 5 is a diagram illustrating a system configuration according to the first example embodiment of the present invention. With reference to FIG. 5, a control apparatus 100 which includes a traffic flow information acquisition part 101, a selection part 102, an instruction part 103, and a base station selection policy storage 104, and controls one or more base stations (gNB) 200 is shown.

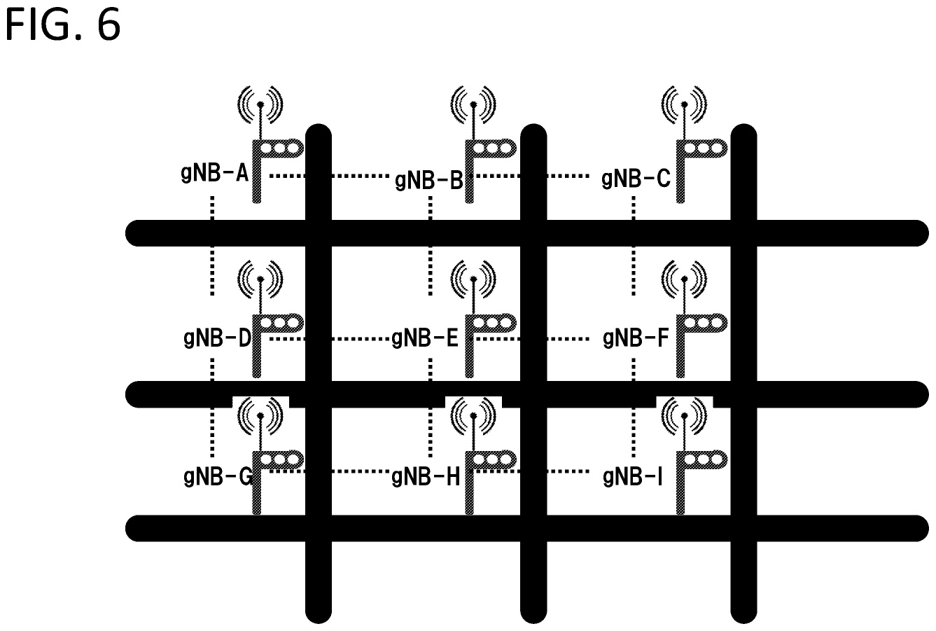

The traffic flow information acquisition part 101 acquires traffic flow information including the number of vehicles or pedestrian which travel between check points from traffic flow sensors installed at roads or traffic lights, through a traffic control center 300. In the description of the present example embodiment below, it is assumed that the traffic control center 300 has acquired traffic flow information of each section for which positions of base stations as show in FIG. 6 are check points from traffic flow sensors installed at road or traffic lights.

FIG. 6 is a diagram illustrating an example of placements of one or more base stations which are control targets of a control apparatus 100 according to the present example embodiment. In the present embodiment below, it is assumed that base stations gNB-A to gNB-I are placed at traffic lights of intersections of roads as shown in FIG. 6 and check points are placed at the same locations. By adopting such a configuration, a traffic volume between check points can be easily grasped by cameras and so on placed at the intersections.

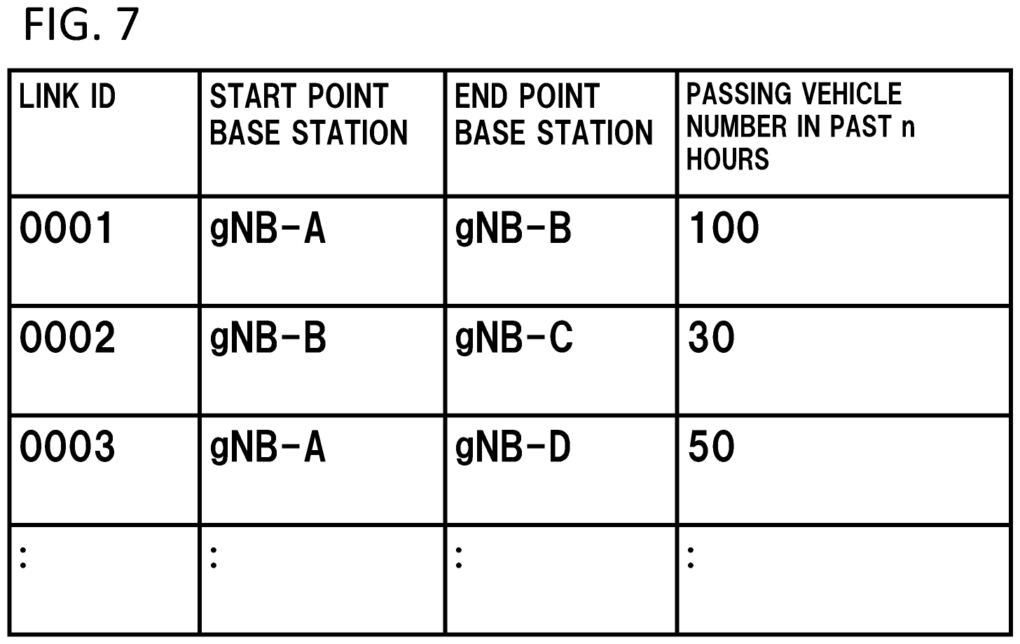

FIG. 7 is a diagram illustrating an example of traffic flow information acquired by the traffic flow information acquisition part 101. In an example as shown in FIG. 7, sections between the base stations gNB-A to gNB-I as shown in FIG. 6 are regarded as links, a link ID is respectively added to each link, and the number of passing vehicles in the past n hours of each link is recorded. Note, although, in the example as shown in FIG. 7, the number of passing vehicles is only recorded, it is possible to use traffic flow information which records the number of pedestrians and so on.

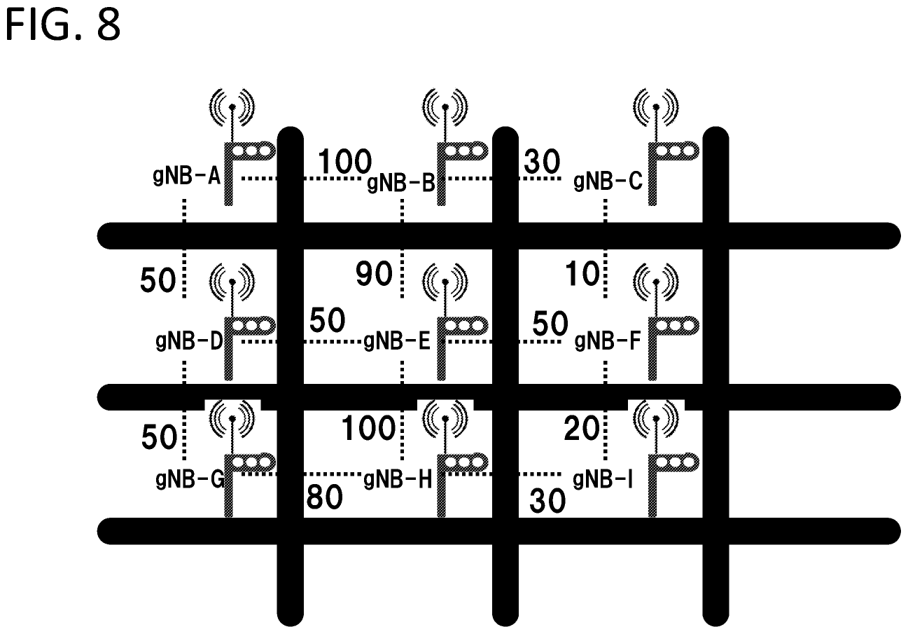

FIG. 8 is a diagram illustrating, as an example, traffic flow information plotted between base stations (check points) on a layout of base stations (check points) as shown in FIG. 5.

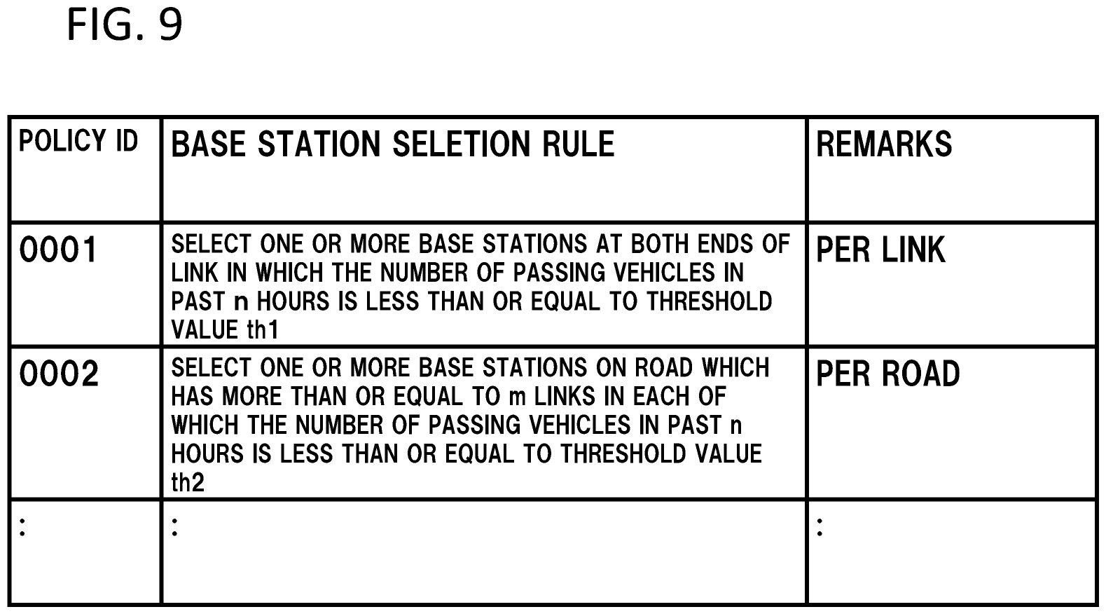

The selection part 102 selects the one or more sections of the road based on the traffic flow information as described above with reference to a base station selection policy stored in the base station selection policy storage 104. FIG. 9 is a diagram illustrating an example of a basestation selection policy held by the base station selection policy storage 104. In an example as shown in FIG. 9, two base station selection policies of a base station selection policy 0001 and a base station selection policy 0002 are set. The base station selection policy 0001 is a policy which is used in a case where it is required to select one or more base stations corresponding to a section in which the number of passing vehicles in the past n hours per link is less than or equal to a threshold value th1, and so on. The base station selection policy 0002 is a policy which is used in a case where it is required to select one or more base stations on a road which has more than or equal to m links in each of which the number of passing vehicles in the past n hours per link is less than or equal to a threshold value th2, and so on. Which policy is selected is determined according to status of a road, content of services and so on to be required to continuously provide by one or more base stations. In addition, the base station selection policy as shown in FIG. 9 is merely an example and it is possible to newly create a policy according to obtainable traffic volume information. For example, as traffic volume information, if the number of passing vehicles for past 30 minutes can be acquired, it is possible to create a policy for selecting one or more base stations corresponding to one or more sections in which the number of passing vehicles for past 30 minutes is less than or equal to a threshold value th3. Of course, the selection part 102 may select one or more base stations by combining a plurality of base station selection policies.

Here, with reference to FIG. 8, an example of selection of base stations in a case where the base station selection policy 0001 as shown in FIG. 9 is selected is described. For example, if, as a threshold value th1, a condition that the number of passing vehicles for the past n hours is less than or equal to 20 is set, sections of roads which satisfy the condition are two sections of gNB-C to gNB-F as shown in FIG. 8 and gNB-F to gNB-I as shown in FIG. 8. In this case, the selection part 102 selects two sections of gNB-C to gNB-F and gNB-F to gNB-I in FIG. 8.

The instruction part 103 instructs the base stations gNB-C, gNB-F, and gNB-I corresponding to the selected sections of the road to execute one or more service restrictions at a predetermined timing. In the present example embodiment, as a service restriction, an instruction to stop providing data other than traffic light information of the traffic lights from the base stations gNB-A to gNB-I placed at intersections is given. By setting such restriction, reducing the power consumption of the corresponding one or more base stations and increasing an operable time after a power outage has occurred can be possible. In addition, in the present example embodiment, in the following description, it is assumed that, in the event of a power outage, the instruction part 103 instructs one or more base stations (gNBs) 200 to execute one or more service restrictions.

One or more base stations (gNBs) 200 are base stations of the fifth-generation mobile communication system installed by telecommunications carriers. In 5G NR (New Radio) developed for the fifth-generation mobile communication system by 3GPP (3rd Generation Partnership Project), it is described to use two frequency bands. A first frequency band is a frequency band from 450 MHz to 6 GHz which is referred to as FR1 (Frequency Range 1) or sub 6 GHz (sub6) in Japan. A second frequency band is a frequency band from 24.250 GHz to 52.600 GHz which is referred to as FR2 (Frequency Range 2). The present example embodiment will be described by assuming that the one or more base stations (gNBs) 200 are base stations which provide services by FR2 that is also referred to as a millimeter waveband. In addition, although an explanation will be made by assuming that the one or more base stations (gNBs) 200 are base stations installed by telecommunications carriers, they may be base stations of a network operated by a local government or the like other than the telecommunications carriers referred to as local 5G.

Furthermore, the base station (gNB) 200 includes a backup power supply (BAT) 201 and can operate using the backup power supply (BAT) 201 in a case of a power outage. As a backup power supply (BAT) 201, a secondary battery such as a lead battery or a lithium-ion battery, or the like, can be used. The backup power supply (BAT) 201 can also concurrently use a fuel cell such as a hydrogen battery as described in PTL 3.

The traffic control center 300 acquires traffic flow information including the number of vehicles or pedestrians travelling between check points from traffic flow sensors installed at roads or traffic lights and provide them to the control apparatus 100.

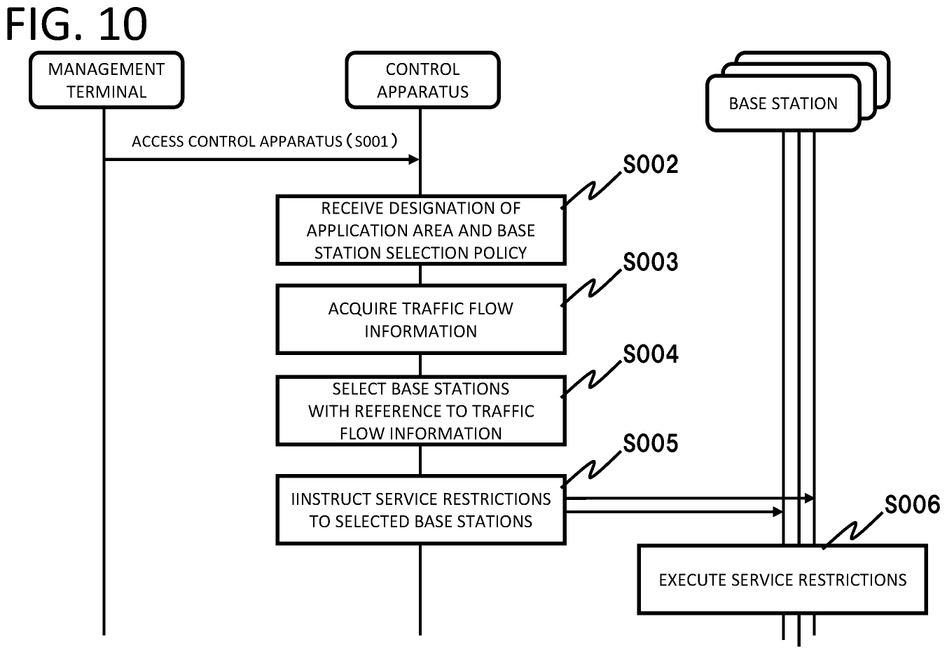

Next, an operation of the present example embodiment will be described in detail with reference to drawings. FIG. 10 is a sequence diagram illustrating an operation of the control apparatus according to the first example embodiment of the present invention. With reference to FIG. 10, an administrator accesses the control apparatus 100 from a management terminal and starts various settings (step S001).

The control apparatus 100 receives designation of an area (application area) in which the one or more base stations (gNBs) 200 which are control targets exist and a base station selection policy from the administrator who operates the management terminal (step S002). In the following description, it is assumed that an area as shown in FIG. 8 is designated and a base station selection policy 0001 as shown in FIG. 9 is selected as a base station selection policy. Note, when the control apparatus 100 receives the designation of the area (application area) in which the one or more base stations (gNBs) 200 which are control targets exist, the control apparatus 100 may provide the administrator with an overview of the area (positions of the one or more base stations, a statistic value of a traffic flow, and so on) which is a control target. Furthermore, the control apparatus 100 may receive changes of threshold values used for the base station selection policy and start timings of service restrictions from the administrator, at the time of designation of the application area or selection of the base station selection policy.

Next, the control apparatus 100 acquires traffic flow information from the traffic control center 300 (step S003). Here, it will be explained by assuming that the control apparatus 100 acquires the traffic flow information equivalent to numerical values plotted in FIG. 8.

Next, the control apparatus 100 selects the one or more base stations using the base station selection policy for which selection is received at step S001 (step S004). Concretely, the control apparatus 100 selects links (sections of roads) which satisfy a condition that the number of passing vehicles in the past n hours is less than or equal to 20 among the traffic flow information as shown in FIG. 8. In an example as shown in FIG. 8, two sections gNB-C to gNB-F and gNB-F to gNB-I satisfy the base station selection policy 0001. Finally, the control apparatus 100 selects gNB-C, gNB-F and gNB-I as base stations corresponding to the sections.

Next, in the event of a power outage, the control apparatus 100 instructs the selected base stations gNB-C, gNB-F and gNB-I to execute one or more service restrictions (step S005). The instruction to execute the service restrictions may be transmitted by the control apparatus 100 at the start timing of the execution, that is, in the event of a power outage, or may be transmitted to each base station from the control apparatus 100 in advance by designating execution timing.

Finally, the base stations gNB-C, gNB-F and gNB-I execute the service restrictions instructed by the control apparatus 100 (step S006).

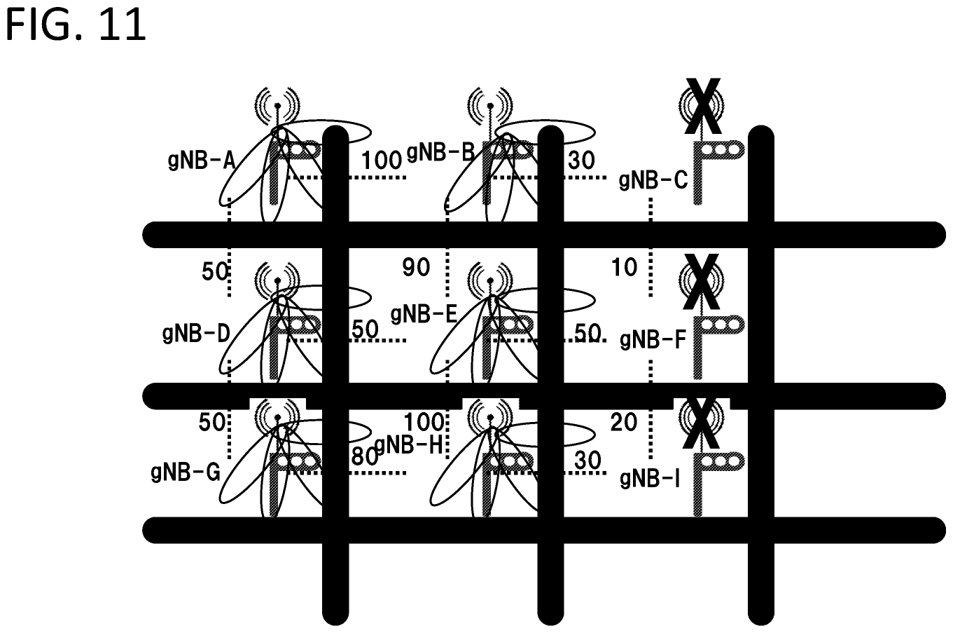

FIG. 11 is a diagram illustrating an operating state of the one or more base stations (gNBs) 200 which received instructions from the control apparatus 100. In an example as shown in FIG. 11, it is shown that the base stations gNB-C, gNB-F and gNB-I to which X marks are added are executing the service restrictions. As a result, in the sections of base stations gNB-C to gNB-F and gNB-F to gNB-I, provision of data other than traffic light information is stopped. However, power consumption of the base stations gNB-C, gNB-F and gNB-I is suppressed and whereby there is an advantage that an operable period can be extended after the power outage occurs.

In addition, in other service provision areas by other base stations (gNBs) other than the base stations gNB-C, gNB-F and gNB-I, data other than traffic light information continues to be provided. As a result, for example, vehicles and pedestrians travelling the corresponding section can receive various information provision, such as congestion information, neighboring store information and so on, and information provision for traffic safety.

In addition, when the power outage is prolonged, it is assumed that base stations (gNBs) other than the base stations gNB-C, gNB-F and gNB-I exhaust backup power supply earlier than the base stations gNB-C, gNB-F and gNB-I and become inoperable. In this case, the instruction part 103 of the control apparatus 100 may instruct the base stations gNB-C, gNB-F and gNB-I to resume the service.

Note, as it is clear from FIG. 11, in place of selecting one or more base stations which execute restrictions of service provision, it is possible to select one or more base stations which do not execute restrictions of service provision and to make other remaining base stations restrict service provision. In this case, in steps S004 and S005, the control apparatus 100 may select gNB-A, gNB-B, gNB-D, gNB-E, gNB-G and gNB-H, exclude them from targets of restrictions of service provision and instruct them to continue the service. Furthermore, after the power outage occurs, the base stations gNB-C, gNB-F and gNB-I execute restrictions of service provision as a prescribed operation at the time of occurrence of the power outage.

### Second Example Embodiment

Although, in the first example embodiment as described above, it is described by assuming that the control apparatus 100 selects one or more base stations as one or more targets of service restrictions using traffic flow information, the control apparatus 100 may select one or more base stations as one or more targets of service restrictions in consideration of other information. In a second example embodiment, an example in which the control apparatus 100 selects one or more base stations which are one or more targets of service restrictions in consideration of a coverage ratio of a service in a control target area will be described.

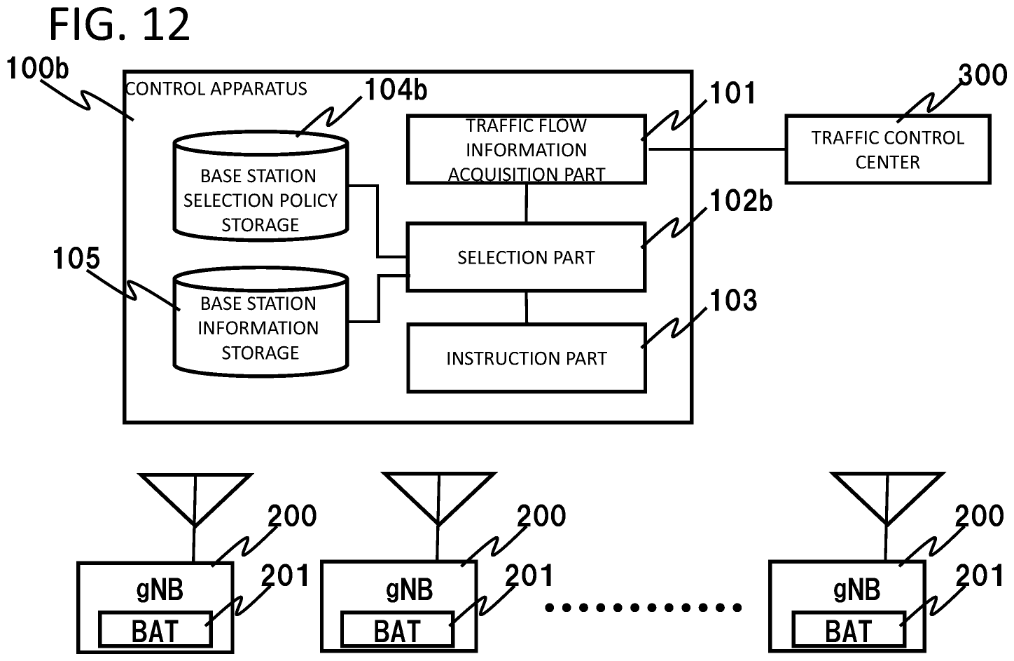

FIG. 12 is a diagram illustrating a system configuration according to the second example embodiment of the present invention. With reference to FIG. 12, a control apparatus 100b which includes a traffic flow information acquisition part 101, a selection part 102b, an instruction part 103, a base station selection policy storage 104b, and a base station information storage 105, and controls one or more base stations (gNBs) 200 is shown. Because the configuration of the control apparatus 100b is basically common to that of the control apparatus 100 according to the first example embodiment, differences between them will be mainly described below.

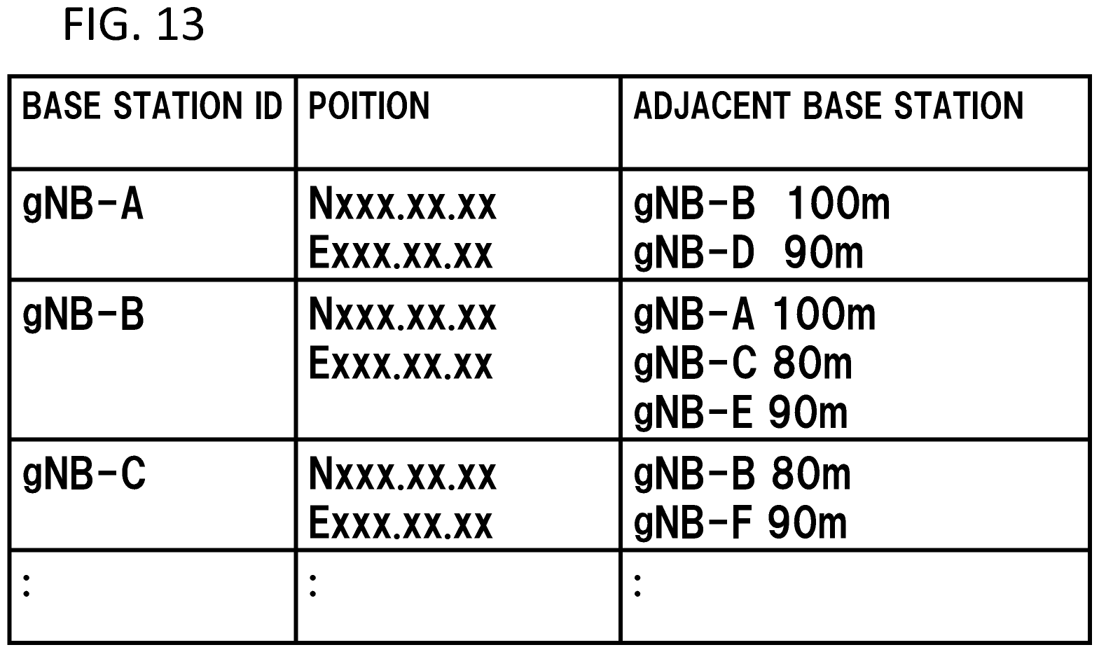

The base station information storage 105 stores base station information which includes positions and distances from the adjacent base stations of one or more base stations in a control target area. FIG. 13 is a diagram illustrating an example of basestation information held by the base station information storage 105. In the example as shown in FIG. 13, for each base station, a position (a latitude and a longitude) and distance information from the adjacent base stations are stored. In a case where a virtual service area radius for each base station is defined, using such position information, it is possible to calculate service coverage in terms of a control target area or a road.

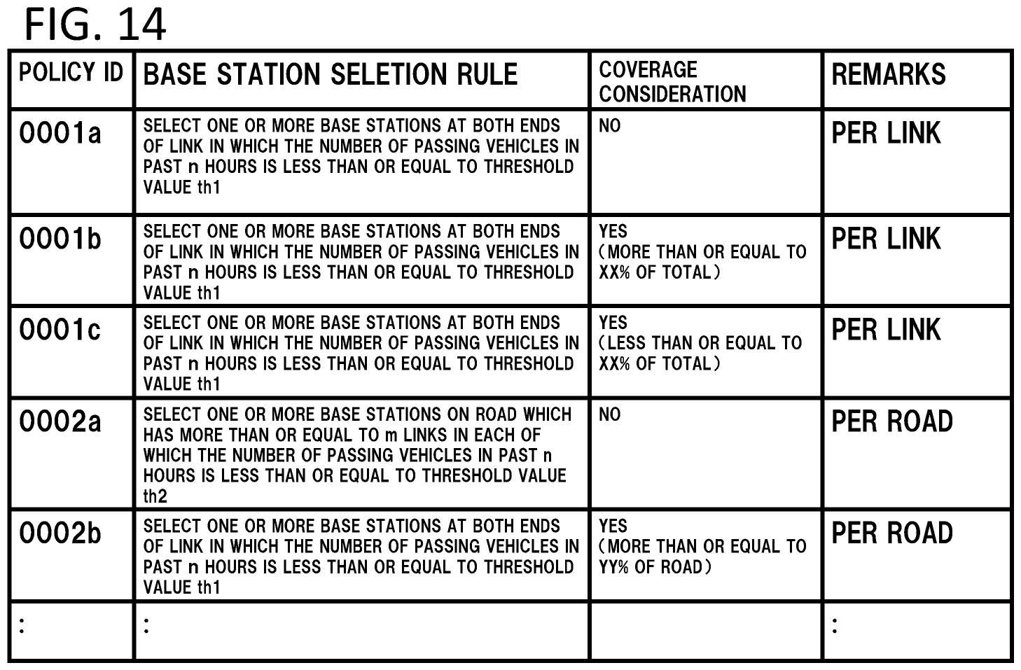

FIG. 14 is a diagram illustrating an example of a base station selection policy held in the base station selection policy storage 104b. A difference from a base station selection policy as shown in FIG. 9 is that “coverage consideration” is added and it is possible to set whether or not to select one or more base stations using the above service coverage in addition to selection of one or more base stations based on a traffic flow. Concretely, in a base station selection policy 0001b as shown in FIG. 14, “coverage consideration” is “yes (more than or equal to XX % of the total)”. If this policy is selected, the control apparatus 100b reselects one or more base stations such that a service coverage of the total control target area becomes more than or equal to XX %. In a base station selection policy 0001c, “coverage consideration” is “yes (less than or equal to XX % of the total)”. If this policy is selected, the control apparatus 100b reselects one or more base stations such that a service coverage of the total control target area becomes less than or equal to XX %. Note, because “coverage consideration” is “no” in a base station selection policy 0001a, in this case, the control apparatus 100b selects one or more base stations in the same way as that of the first example embodiment.

Similarly, in a base station selection policy 0002b as shown in FIG. 14, “coverage consideration” is “yes (YY % of a road)”. If this policy is selected, the control apparatus 100b selects one or more base stations such that a service coverage of all the roads becomes more than or equal to YY %. Note, because “coverage consideration” is “no” in a base station selection policy 0002a, in this case, the control apparatus 100b selects one or more base stations in the same way as that of the first example embodiment.

The selection part 102b selects one or more base stations based on a service overage with reference to the base station information storage 105, in addition to selection of one or more base stations based on traffic flow information in the same way as that of the first example embodiment.

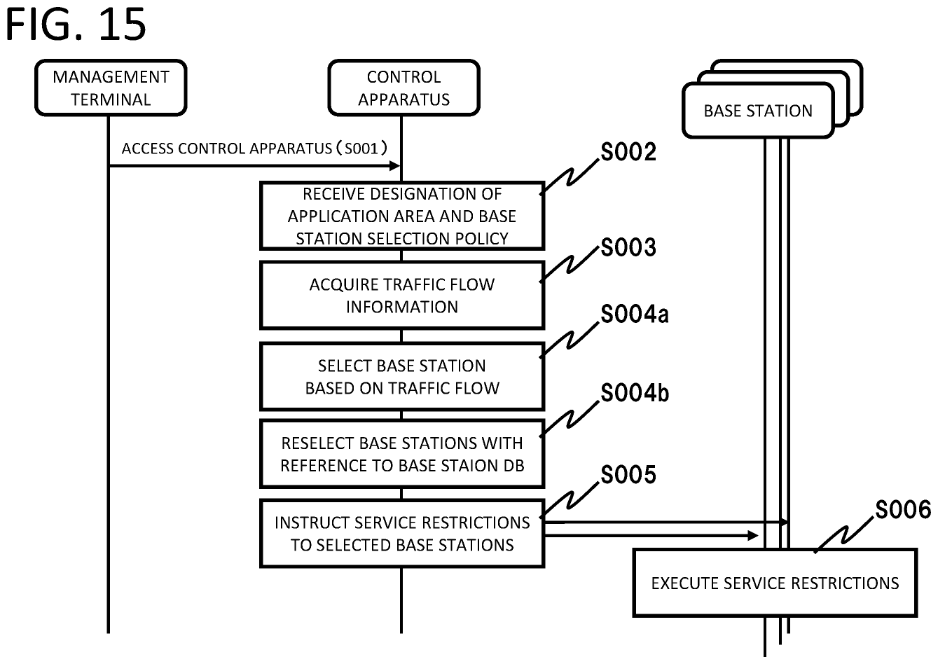

Next, an operation of the present example embodiment will be described in detail with reference to drawings. FIG. 15 is a sequence diagram illustrating an operation of the control apparatus according to the second example embodiment of the present invention. The operations from step S001 to step S004s as shown in FIG. 15 are the same as those from step S001 to step S004 of the first example embodiment, the description will be omitted. In the following description, it is assumed that the area as shown in FIG. 8 is designated. In addition, it is assumed that values plotted in FIG. 8 have been acquired as traffic flow information in the same way as the first example embodiment.

In step S004a as shown in FIG. 15, the base stations gNB-C, gNB-F and gNB-I as shown in FIG. 8 are selected in the same way as that in step S004 of the first example embodiment. Next, the control apparatus 100b calculates a service coverage of the total area using base station information held in the base station information storage 105 and reselects one or more base stations based on the result (step S004b).

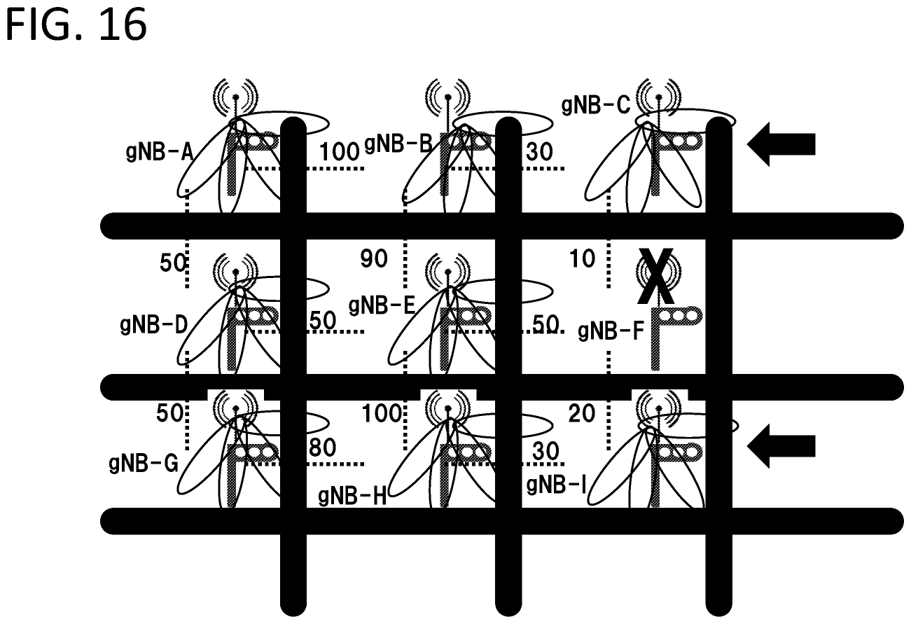

For example, in a case where the base station selection policy 0001b is designated, the control apparatus 100b performs the following operation. If a coverage threshold values XX % designated in the base station selection policy 0001b is 80%, the control apparatus 100b calculates whether or not an area coverage by one or more base stations other than the base stations gNB-C, gNB-F and gNB-I is more than or equal to 80%. Then, as a result of the calculation, in a case where the area coverage by the one or more base stations other than the base stations gNB-C, gNB-F and gNB-I is less than 80%, the control apparatus 100b reselects one or more base stations to be excluded from targets of service restrictions from among the base stations gNB-C, gNB-F and gNB-I. FIG. 16 shows an example in which the base stations gNB-C and gNB-I are excluded from the targets of the service restrictions as a result of the above reselection. By doing this, it becomes possible to select one or more base stations in consideration of a coverage of the total area in addition to selection of one or more base stations using traffic flow.

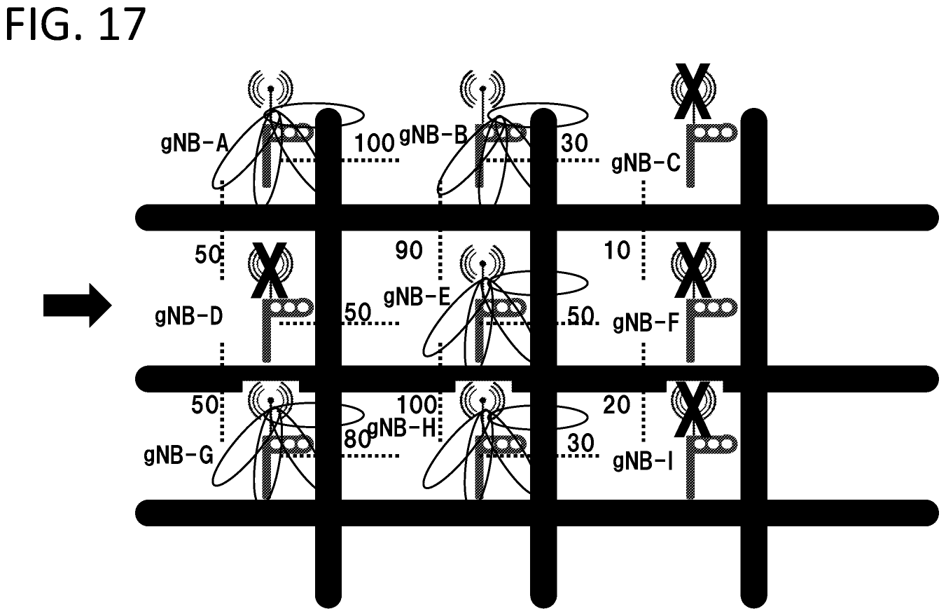

Furthermore, for example, in a case where the base station selection policy 0001c is designated, the control apparatus 100b performs the following operation. If a coverage threshold values XX % designated in the base station selection policy 0001c is 60%, the control apparatus 100b calculates whether or not an area coverage by one or more base stations other than the base stations gNB-C, gNB-F and gNB-I is less than 60%. Then, as a result of the calculation, in a case where the area coverage by the one or more base stations other than the base stations gNB-C, gNB-F and gNB-I is more than or equal to 60%, the control apparatus 100b reselects one or more base stations to be excluded from targets of service restrictions in addition to the base stations gNB-C, gNB-F and gNB-I. FIG. 17 shows an example in which the base stations gNB-D is added to a target of the service restrictions as a result of the above reselection. By doing this, it becomes possible to select one or more base stations in consideration of a coverage of the total area in addition to selection of one or more base stations using traffic flow.

The exemplary embodiments of the present invention have been described as above, however, the present invention is not limited thereto. Further modifications, substitutions, or adjustments can be made without departing from the basic technical concept of the present invention. For example, the configurations of the apparatuses and the elements and the representation modes of the data or the like illustrated in the individual drawings are merely used as examples to facilitate the understanding of the present invention. Thus, the present invention is not limited to the configurations illustrated in the drawings. For example, the first example embodiment described above in which intersections are used as check points and traffic flow between them are used has been described but setting of check points is not limited thereto. For example, it is possible to use set positions of measurement sensors of traffic flows installed at road sides as the check points.

Furthermore, although, in the example embodiments as descried above, the example in which traffic flow of vehicles is used as an index to show the number of moving bodies travelling between the check points is described, it is also applicable to use to select one or more base stations which execute service restrictions using pedestrian based traffic flow. For example, in an event site and so on, it is also applicable to select one or more base stations which execute service provision restrictions based on human flow.

For example, in the example embodiment described above, the example in which the base stations are 5G base stations has been described, but the base stations to which the present invention can be applied are not limited to 5G base stations. For example, the present invention is applicable when the service restrictions are executed by base stations of LTE (Long Term Evolution) or access points of a wireless LAN (Local Area Network).

Furthermore, in the example embodiment described above, the example in which one or more base stations which execute service provision restrictions are selected after start of power outage is described, but application of the present invention is not limited to a case of the power outage. For example, in a case where an electric power company requests a power saving and so on, it is applicable to select one or more base stations which execute service provision restrictions. Furthermore, for example, it is applicable to select one or more base stations which execute service provision restrictions at areas in which traffic volume widely fluctuates during night-time and holidays.

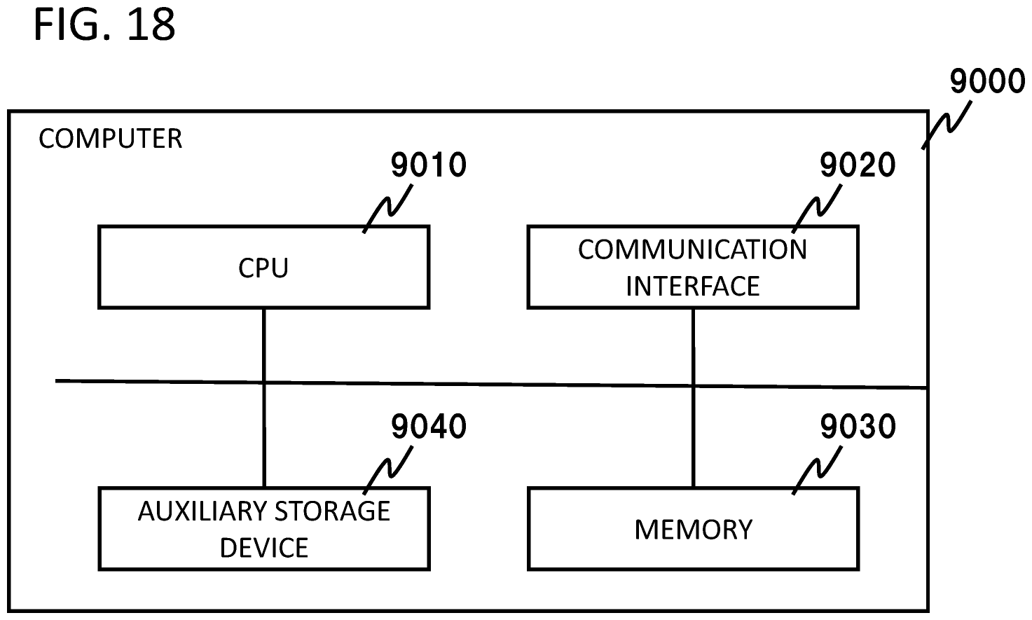

In addition, the procedures described in the above each example embodiment can each be realized by a program causing a computer (9000 in FIG. 18) functioning as the corresponding control apparatus to realize the functions as the corresponding control apparatus. For example, this computer is configured to include a CPU (Central Processing Unit) 9010, a communication interface 9020, a memory 9030, and an auxiliary storage device 9040 in FIG. 18. That is, the CPU 9010 in FIG. 18 executes a traffic flow information acquisition program and a base station selection program.

That is, the individual parts (processing means, functions) of each of the control apparatuses 100, 100a, and 100b as described above can each be realized by a computer program that causes a processor mounted on the corresponding apparatus to execute the corresponding processing described above by using corresponding hardware.

Finally, suitable modes of the present invention will be summarized.

### [Mode 1]

(See the control apparatus according to the above first aspect)

### [Mode 2]

The one or more service restrictions can include to stop providing the moving bodies with signal information indicating a state of a light of a traffic light.

### [Mode 3]

The one or more base stations respectively include a backup power supply, and

the control apparatus as described above may have a configuration in which when a power outage occurs, the means for instructing to execute one or more service restrictions instruct the one or more base stations to execute the one or more service restrictions.

### [Mode 4]

The control apparatus as described above may have a function, when the one or more base stations which are not one or more targets to the one or more service restrictions become inoperable, to instruct the one or more base stations to which execution of the one or more service restrictions are instructed to resume the service.

### [Mode 5]

The control apparatus as described above further has base station selection policy storage which holds a selection policy of the base station which defines the selection policy of the base station, wherein, using the base station selection policy selected by a manager, the control apparatus selects the one or more sections or the one or more base stations.

### [Mode 6]

The control apparatus as described above further may have a configuration in which, as the base station selection policy, the control apparatus can set the base station selection policy which selects the one or more sections or the one or more base stations based on the number of moving bodies travelled between the check points within a predetermined past time period.

### [Mode 7]

The control apparatus as described above further may have a configuration in which, as the base station selection policy, the control apparatus can further set the base station selection policy which selects the one or more sections or the one or more base stations based on a service coverage rate by the base stations at an area or the road in which the base stations are placed.

### [Mode 8]

(See the control method according to the above second aspect)

### [Mode 9]

(See the recording medium recording a program according to the above third aspect)

The above modes 8 and 9 can be expanded to the modes 2 to 7 in the same way as the mode 1 is expanded.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, as needed and based on the gist of the present invention, the individual disclosed matters in the above literatures, as a part of the disclosure of the present invention, and partial or entire use of the individual disclosed matters in the above literatures that have been referred to in combination with what is disclosed in the present application, should be deemed to be included in what is disclosed in the present application.

### REFERENCE SIGNS LIST

100a, 100b control apparatus
101, 101a traffic flow information acquisition part
102, 102a, 102b selection part
103, 103a instruction part
104, 104b base station selection policy storage
105 base station information storage
200 base station (gNB)
201 backup power supply (BAT)
300 traffic control center
9000 computer
9010 CPU
9020 communication interface
9030 memory
9040 auxiliary storage device

What is claimed is:

1. A base station control apparatus, comprising:
at least a processor; and
a memory in circuit communication with the processor,
wherein the processor is configured to execute program instructions stored in the memory to implement:
acquiring a number of moving bodies which travel between check points installed along a road;
selecting one or more sections of the road based on the number of moving bodies which travel between the check points; and
instructing the one or more base stations corresponding to the selected one or more sections of the road to execute one or more service restrictions at a predetermined timing.

2. The base station control apparatus according to claim 1,
wherein the one or more service restrictions include to stop providing the moving bodies with signal information indicating a state of a light of a traffic light.

3. The base station control apparatus according to claim 1,
wherein the one or more base stations respectively comprise a backup power supply, and
wherein, when a power outage occurs, the instructing to execute one or more service restrictions instructs the one or more base stations to execute the one or more service restrictions.

4. The base station control apparatus according to claim 1,
wherein, when the one or more base stations which are not one or more targets to the one or more service restrictions become inoperable, the instructing to execute one or more service restrictions instructs the one or more base stations to which execution of the one or more service restrictions are instructed to resume a service.

5. The base station control apparatus according to claim 1, further comprising a base station selection policy storage which holds a selection policy of the base station which defines a selection policy of the base station,
wherein, using the base station selection policy selected by a manager, the base station control apparatus selects the one or more sections or the one or more base stations.

6. The base station control apparatus according to claim 5,
wherein, as the base station selection policy, the base station control apparatus can set a base station selection policy which selects the one or more sections or the one or more base stations based on the number of moving bodies travelled between the check points within a predetermined past time period.

7. The base station control apparatus according to claim 5,
wherein, as the base station selection policy, the base station control apparatus can further set a base station selection policy which selects the one or more sections or the one or more base stations based on a service coverage rate by the base stations at an area or the road in which the base stations are placed.

8. A base station control method, wherein
a control apparatus of one or more base stations which form a service area corresponding to one or more sections of a road comprises:
acquiring a number of moving bodies which travel between check points installed along the road;
selecting one or more sections of the road based on the number of moving bodies which travel between the check points; and
instructing the one or more base stations corresponding to the selected one or more sections of the road to execute one or more service restrictions at a predetermined timing.

9. A computer-readable non-transitory recording medium recording a program, the program causing a computer mounted on a control apparatus of one or more base stations which forms a service area corresponding to one or more sections of a road, to perform processings of:
acquiring a number of moving bodies which travel between check points installed along the road;
selecting one or more sections of the road based on the number of moving bodies which travel between the check points; and
instructing the one or more base stations corresponding to the selected one or more sections of the road to execute one or more service restrictions at a predetermined timing.

10. The base station control method according to claim 8,
wherein the one or more service restrictions include to stop providing the moving bodies with signal information indicating a state of a light of a traffic light.

11. The base station control method according to claim 8,
wherein the one or more base stations respectively comprise a backup power supply, and
wherein, when a power outage occurs, the base station control apparatus instructs the one or more base stations to execute the one or more service restrictions.

12. The base station control method according to claim 8,
wherein, when the one or more base stations which are not one or more targets to the one or more service restrictions become inoperable, the base station control apparatus instruct the one or more base stations to which execution of the one or more service restrictions are instructed to resume a service.

13. The base station control method according to claim 8, the base station control apparatus further comprising a base station selection policy storage which holds a selection policy of the base station which defines a selection policy of the base station,
wherein, using the base station selection policy selected by a manager, the base station control apparatus selects the one or more sections or the one or more base stations.

14. The base station control method according to claim 8,
wherein, as the base station selection policy, the base station control apparatus can set the base station selection policy which selects the one or more sections or the one or more base stations based on the number of moving bodies travelled between the check points within a predetermined past time period.

15. The base station control method according to claim 8,
wherein, as the base station selection policy, the base station control apparatus can further set a base station selection policy which selects the one or more sections or the one or more base stations based on a service coverage rate by the base stations at an area or the road in which the base stations are placed.

16. The computer-readable non-transitory recording medium according to claim 9,
wherein the one or more service restrictions include to stop providing the moving bodies with signal information indicating a state of a light of a traffic light.

17. The computer-readable non-transitory recording medium according to claim 9,
wherein the one or more base stations respectively comprise a backup power supply, and
wherein, when a power outage occurs, the program causing a computer to perform processing of instructing the one or more base stations to execute the one or more service restrictions.

18. The computer-readable non-transitory recording medium according to claim 9,
wherein, when the one or more base stations which are not one or more targets to the one or more service restrictions become inoperable, the program causing a computer to perform processing of instructing the one or more base stations to which execution of the one or more service restrictions are instructed to resume a service.

19. The computer-readable non-transitory recording medium according to claim 9, the base station control apparatus further comprising a base station selection policy storage which holds a selection policy of the base station which defines a selection policy of the base station,
wherein, using the base station selection policy selected by a manager, the program causing a computer to perform processing of selecting the one or more sections or the one or more base stations.

20. The computer-readable non-transitory recording medium according to claim 9,
wherein, as the base station selection policy, the program causing a computer to perform processing of setting a base station selection policy which selects the one or more sections or the one or more base stations based on the number of moving bodies travelled between the check points within a predetermined past time period.
